(19) United States
(12) Patent Application Publication
(10) Pub. No.: US 2007/0182398 A1
(43) Pub. Date: Aug. 9, 2007

(54) Voltage regulator in semiconductor memory device

(76) Inventor: Wook-Ghee Hahn, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/698,945

(22) Filed: Jan. 29, 2007

(30) Foreign Application Priority Data
Feb. 9, 2006 (KR) 2006-12709

(51) Int. Cl. G05F 1/00

(52) U.S. Cl. 323/285

(57) ABSTRACT

Provided is a voltage regulator. The voltage regulator includes a level down shifter reducing an applied high voltage, a voltage divider dividing the reduced high voltage to generate a first division result, a comparator comparing a reference voltage to the first division result, and a driver generating an output voltage based on the comparison result and providing the output voltage to the voltage divider. The voltage divider divides the output voltage to generate a second division result serving as a voltage control signal fed back to the level down shifter.

### BACKGROUND OF THE INVENTION

1. Field of the Invention

The present invention relates to nonvolatile memory devices. More particularly, the invention relates to a voltage regulator circuit used within an electrically erasable nonvolatile memory device.

This non-provisional patent application claims priority under 35 U.S.C. § 119 to Korean Patent Application No. 2006-12709, filed on Feb. 9, 2006, the subject matter of which is hereby incorporated by reference.

2. Discussion of Related Art

The evolution of semiconductor memory devices is one marked by increasing integration density and a corresponding reduction in the overall size of constituent components and circuits.

Semiconductor memory devices may be generally classified as volatile and nonvolatile memory devices. Volatile memory devices lose stored data when power is turned off. In contrast, nonvolatile memory devices, such as a mask ROM (MROM), a programmable ROM (PROM), an erasable and programmable ROM (EPROM) and an electrically erasable and programmable ROM (EEPROM), retain stored data when power is no longer applied. Among other forms of nonvolatile memory devices, flash memory devices are widely used in computers, memory cards, etc., because of their ability to simultaneously and electrically erase a block of memory cells, their high integration density, along with other features and characteristics.

Flash memory devices generally operate in three principal modes; programming, erasing and reading. To perform these operations, flash memory devices commonly require higher operating voltages than conventional power supply voltages. These relatively “high voltages” are generated by circuits internal to the flash memory device, because the external application of such voltages tends to interfere with operations and may actually damage internal components, such as transistors. Accordingly, flash memory devices internally generate high voltages in relation to such factors as constituent transistor threshold voltage(s), dielectric breakdown voltage(s), etc.

Within flash memory devices, a charge pump within a boosting circuit is commonly used to boost a relatively lower power supply voltage(s) in order to generate one or more level voltages.

A high voltage generated by a charge pump may be converted into a constant voltage by use of a voltage regulator. Conventional voltage regulators are implemented with low voltage transistors.

In contemporary flash memory devices, a high voltage Vpp greater than a power supply voltage Vdd is used as an input voltage. As a result, a level down shifter reduces the high voltage Vpp to a lower predetermined voltage level. Such level down shifters are often located between an input terminal of a voltage regulator and a corresponding low voltage transistor. A high voltage transistor having operational durability to high voltage signals is typically used to implement the level down shifter.

The output of the high voltage transistor within the level down shifter is adjusted in response to a control voltage applied to the control gate of the high voltage transistor. This control voltage is typically generated by a separate control circuit. The control circuit adjusts the level of the control voltage in accordance with the desired constant voltage level. Therefore, the amount of current flowing through the high voltage transistor may be adjusted to output a target voltage level.

Unfortunately, the conventional necessity of providing a separate (additional) control circuit for this purpose adversely impedes efforts to reduce the overall size of the flash memory device.

### SUMMARY OF THE INVENTION

Embodiments of the present invention provide a voltage regulator capable of generating a stable constant voltage without the necessity of providing a separate additional control circuit.

In one embodiment, the invention provides a voltage regulator, comprising; a level down shifter reducing a high voltage, a voltage divider dividing the reduced high voltage to generate a first division result, a comparator comparing a reference voltage to the first division result to generate a comparison result, and a driver generating an output voltage based on the comparison result and providing the output voltage to the voltage divider, wherein the voltage divider divides the output voltage to generate a second division result, the second division result being fed back as a control voltage signal to the level down shifter.

In another embodiment, the invention provides a voltage regulator generating an output voltage at an output terminal, comprising; a level down shifter reducing a high voltage, a switch receiving the reduced high voltage and an enable signal, a first driver gated by an output of the switch to output the reduced high voltage, a second driver gated by the output of the first driver to output the reduced high voltage as the output voltage at the output terminal, a ripple eliminator connected between the output of the first driver and the output terminal, a voltage divider dividing the output voltage provided by the second driver to generate a first division result and a second division result, and a comparator comparing a reference voltage to the first division result to generate a comparison result, wherein the second driver generates the output voltage in relation to the comparison result voltage divider and wherein the second division result is fed back as a control voltage signal to the level down shifter.

### BRIEF DESCRIPTION OF THE FIGURE

FIG. 1 is a circuit diagram illustrating an exemplary voltage regulator according to an embodiment of the present invention.

### DESCRIPTION OF EMBODIMENTS

Preferred embodiments of the invention will be described below with reference to the accompanying drawing. The present invention may, however, be embodied in many different forms and should not be constructed as being limited to only the illustrated embodiments. Rather, these embodiments are presented as teaching examples.

A voltage regulator according to embodiments of the invention comprises a level down shifter configured to reduce an input high voltage, a voltage divider dividing the reduced input high voltage to generate a first division result, a comparator comparing a predetermined reference voltage to the first division result, and a driver generating an output voltage based on the comparison result and providing the output voltage to the voltage divider. The voltage divider then divides the output voltage to generate a second division result and feeds the second division result back as a control voltage controlling the output of the level down shifter. With this type of implementation, a control voltage and an output voltage having a constant voltage level may be stably generated without the necessity of an additional circuit generating a control signal.

In the more detailed description that follows, a voltage regulator, similar to the class of circuits found in conventional nonvolatile memory devices such as a flash memory devices, is illustrated in the context of an embodiment of the invention. However, those skilled in the art will recognize other advantages and applications of the present invention. That is, embodiments of the invention may be variously implemented or applied to other types of semiconductor devices. In addition, the specific design details (e.g., component type and size, operating voltage levels, nature of control signals, etc.) presented hereafter may be modified or altered without departing from the scope of the present invention.

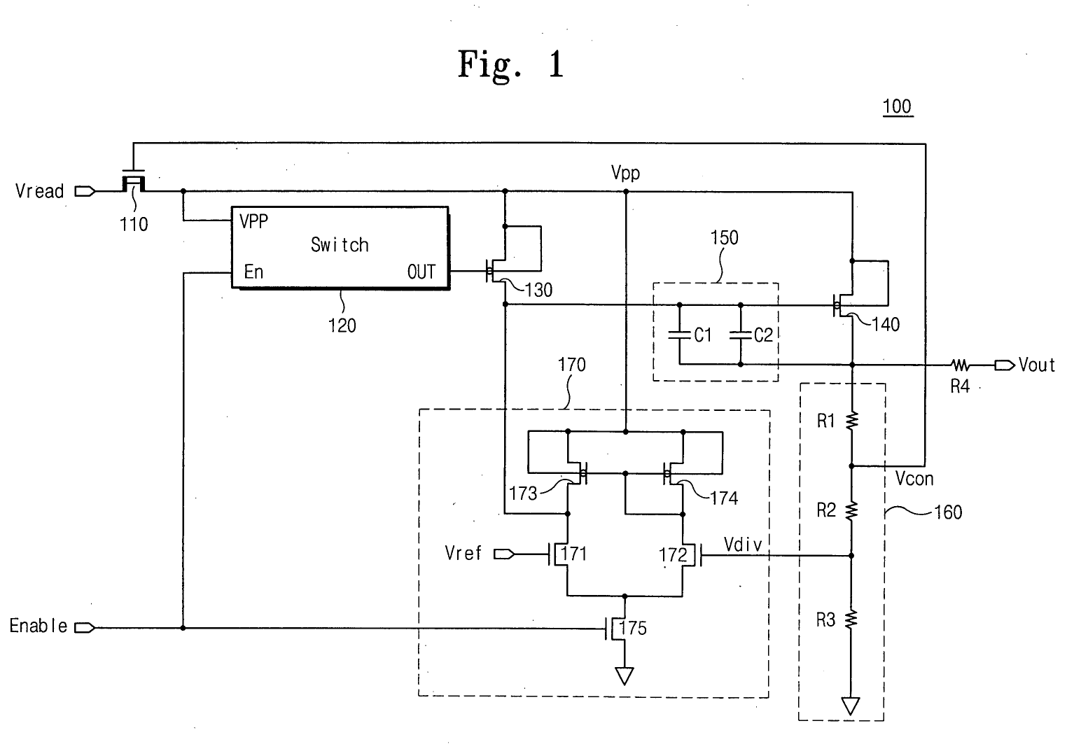

A voltage regulator according to an embodiment of the invention will now be described in the context of the circuit diagram show in FIG. 1. Voltage regulator 100 is configured to regulate a read voltage signal (Vread) within a flash memory device. As illustrated, voltage regulator 100 comprises a level down shifter 110, a switch 120, a first driver 130, a second driver 140, a ripple eliminator 150, a voltage divider 160 and a comparator 170.

Level down shifter 110 reduces the voltage of the Vread signal, which is provided at a relatively high voltage generated by a charge pump (not shown), for example, down to a predetermined high voltage Vpp. The high voltage Vpp is then provided to switch 120, first driver 130, second driver 140, and comparator 170.

Level down shifter 110 may be implemented using a high voltage, depletion-type transistor which serves to protect the low voltage transistors forming voltage regulator 100 from damage due to over-voltage conditions. That is, level down shifter 110 conditions the Vread signal generated by a charge pump to generate the high voltage Vpp having a relatively lower level defined in relation to the breakdown voltage of the low voltage transistors in voltage regulator 100.

Those skilled in the art will recognize that a channel is formed in the depletion type transistor used to implement level down shifter 110 even when a voltage is not applied its gate terminal. Thus, although voltage regulator 100 may at times become inactive, level down shifter 110 nonetheless generate the high voltage Vpp.

The high voltage Vpp generated during inactive periods of voltage regulator 100 will have a voltage level defined as, Vread minus the threshold voltage (Vth) of the depletion type transistor implementing level down shifter 110.

However, when voltage regulator 100 is activated, the source voltage output of the depletion type transistor implementing level down shifter 110 is adjusted by the level of a control voltage signal (Vcon) applied to its gate terminal. That is, the control voltage adjusts the width of the channel formed in depletion type transistor forming level down shifter 110 to thereby determine the level of the source voltage which is output as high voltage Vpp of level down shifter 110. As will be described below in some additional detail, the control voltage signal (Vcon) applied to the depletion type transistor forming level down shifter 110 is a feedback voltage from a voltage division result generated by voltage divider 160. Therefore, the control voltage signal (Vcon) will have a predetermined lower voltage level than that of output voltage (Vout) generated by voltage regulator 100.

Due to the inherent characteristics of voltage regulator 100, the output voltage (Vout) will converge to a predetermined level. Thus, the control voltage signal (Vcon) having a predetermined level lower than the output voltage (Vout) will also converge to a predetermined level. Therefore, a stable control voltage signal (Vcon) may be generated using a relatively simple, internal circuit configuration (e.g., a voltage division circuit in the illustrated example). Thus, no additional control circuit is required to generate the control voltage signal (Vcon).

Switch 120 electrically connects high voltage Vpp provided by level down shifter 100 to an output terminal (OUT) in response to an applied enable signal (Enable). The enable signal (Enable) indicates activation period for voltage regulator 100 and is provided by an external controller (not shown). For example, when the enable signal (Enable) is applied at a logically “high” level, switch 120 provides high voltage Vpp to the output terminal (OUT). On the other hand, when the enable signal (Enable) is applied at a logically “low” level, switch 120 interrupts the provision of output high voltage Vpp to the output terminal (OUT). The resulting output signal from switch 120 is provided to first driver 130.

In the illustrated example, first driver 130 is implemented using a first drive transistor having a gate terminal connected to the output terminal (OUT) of switch 120. The first drive transistor is a p-metal-oxide-semiconductor (PMOS) transistor where the source terminal is connected to an output terminal of the level down shifter 110 and the drain terminal is connected to the second driver 140, the ripple eliminator 150 and the comparator 170. This, the first drive transistor is switched ON and OFF by the output of switch 120 apparent at output terminal (OUT).

For example, when the output of switch 120 is high, which corresponds in the illustrated example to an active or high enable signal (Enable), the first drive transistor is turned OFF. As this result, a source-drain current path of the first drive transistor is interrupted (turned OFF) to generate a low level drain voltage. On the other hand, when the output of switch 120 is low, which corresponds in the illustrated example to an inactive or low enable signal (Enable), the first drive transistor is turned ON to generate a high level drain voltage. The drain voltage of the first drive transistor has a voltage level that corresponds to the high voltage Vpp reduced by the threshold voltage Vth of the first drive transistor. The output voltage (i.e., the drain voltage of the first drive transistor) of first driver 130 is provided to second driver 140.

Second driver 140 is implemented with a second drive transistor having a gate terminal connected to the drain of the first drive transistor. In the illustrated example, the second drive transistor is the PMOS transistor having a source connected to the output of level down shifter 110, and a drain connected to voltage divider 160. Ripple eliminator 150 is connected between the drain and gate of the second drive transistor.

The second drive transistor is switched ON and Off by the output of first driver 130. For example, when the output of first driver 130 is high, the second drive transistor is turned OFF to generate a low level drain voltage. When the output of first driver 130 is low, the second drive transistor is turned ON to generate a high level drain voltage. The drain voltage of the second drive transistor thus equals the high voltage Vpp minus the threshold voltage Vth of the second drive transistor. The output voltage of second driver 140 is provided to voltage divider 160.

As illustrated in FIG. 1, voltage divider 160 includes a plurality of resistors R1 through R3 connected in series between the drain of the second drive transistor and ground. Voltage divider 160 divides the voltage apparent at the drain of the second drive transistor according to a predetermined resistance ratio to provide a first division result (Vdiv) to comparator 170 and a second division result as the control voltage signal (Vcon) feedback to level down shifter 110.

The first and second division results (Vdiv and Vcon) may have various levels by adjusting the resistance ratio between resistors R1 though R3 included in voltage divider 160. As such, the second division result (Vcon) serving as the control voltage signal will have a predetermined level lower than the output voltage (Vout) of voltage regulator 100. In the illustrated embodiment, the second division result and voltage control signal (Vcon) is adjusted such that generated output voltage (Vout) of voltage regulator 100 is sufficiently high, yet well below the breakdown voltage of the low voltage transistors forming voltage regulator 100.

For example, in one embodiment, it is assumed that a high voltage Vpp of 4 V is required for voltage regulator 100 to generate an output voltage (Vout) of 3.5 V. Assuming a threshold voltage (Vth) for the high voltage transistor implementing level down shifter 110 is 1.5 V, a resulting voltage apparent at resistor R1 will be 2.5 V. This voltage may then be fed back as control voltage signal (Vcon). Under these assumptions, the output of level down shifter 110 will be equal to or higher than the sum of the threshold voltage of the high voltage transistor forming level down shifter 110 and the control voltage signal (Vcon) but lower than the breakdown voltages of the low voltage transistors forming voltage regulator 100. The development of the control voltage signal (Vcon) may be adjusted in other implementations, as defined by a range related to high voltage Vpp and the various transistor breakdown voltage(s) forming voltage regulator 100.

In FIG. 1, comparator 170 includes a first transistor 171 receiving a reference voltage (Vref) through a gate terminal, a second transistor 172 receiving the first division result (Vdiv) through a gate terminal and a discharge transistor 175 commonly connected to source terminals of first transistor 171 and second transistor 172. Although not shown in FIG. 1, those skilled in the art will understand that the reference voltage (Vref) is generated by dividing a predetermined voltage level, such as a power supply voltage Vdd. First transistor 171, second transistor 172 and discharge transistor 175 may be implemented as N-type metal-oxide-semiconductor (NMOS) transistors. The enable signal (Enable) is applied to a gate of discharge transistor 175. The drain terminal of discharge transistor 175 is commonly connected to the source terminals of first and second transistors 171 and 172. The source terminal of discharge transistor 175 is connected to ground. Discharge transistor 175 discharges current from first and second transistors 171 and 172 responsive to the applied enable signal (Enable).

Additionally, third and fourth transistors 173 and 174 are connected to the drain terminals of first and second transistor 171 and 172, respectively. Third and fourth transistors 173 and 174 may be implemented as PMOS transistors. The high voltage Vpp generated by level down shifter 110 is commonly applied to source terminals of third and fourth transistors 173 and 174. Gate terminals of third and fourth transistors 173 and 174 are commonly connected to the drain terminal of fourth transistor 174. Also, the drain terminal of third transistor 173 is commonly connected to the drain terminal of first transistor 171 and the drain terminal of the first drive transistor.

Assuming in relation to the working example illustrated in FIG. 1, that the enable signal (Enable) is active, the operation of comparator 170 will be described below.

First and second transistors 171 and 172 receive the reference voltage (Vref) and the first division result (Vdiv) generated from voltage divider 160 through their gate terminals, respectively. The current driving ability of first and second transistor 171 and 172 is determined according to the magnitudes of the reference voltage (Vref) and the first division result (Vdiv) applied to the respective gates. For example, when the first division result (Vdiv) is higher than the reference voltage (Vref), the current driving ability of second transistor 172 is greater than that of first transistor 171. Accordingly, second transistor 172 discharges an amount of current greater than that of first transistor 171 through discharge transistor 175. With this result, the drain voltage of second transistor 172 is lower than that of first transistor 171.

The lower drain voltage of second transistor 172 is applied to the gate terminals of third and fourth transistor 173 and 174, which are commonly connected to the drain of second transistor 172, to thereby improve the current driving ability of third and fourth transistor 173 and 174. As a result, the drain voltage of first transistor 171 is increased.

As further illustrated in FIG. 1, the drain terminal of first transistor 171 is connected to the drain terminal of the first drive transistor forming first driver 130. Accordingly, the increased drain voltage of first transistor 171 increases the drain voltage of the first drive transistor. The increased drain voltage of the first drive transistor is applied to the gate terminal of the second drive transistor to reduce the current driving ability of the second drive transistor. Therefore, the drain voltage of the second drive transistor is decreased.

That is, when the first division result (Vdiv) applied to comparator 170 is higher than a predetermined reference voltage (Vref), a voltage applied to voltage divider 160 becomes lower. On the contrary, when the first division result (Vdiv) is lower than the predetermined reference voltage (Vref), a voltage applied to voltage divider 160 becomes higher. According to the above example, a voltage level applied to voltage divider 160, that is, the output voltage of second driver 140 can be constantly maintained to be a predetermined value. The output voltage of second driver 140 (that is, the drain voltage of the second drive transistor) is applied to voltage divider 160 and simultaneously is dropped by a predetermined level through a resistor R4 to be output as the output signal (Vout) of voltage regulator 100.

In the illustrated example, ripple eliminator 150 is connected to the drain terminal of the second drive transistor forming second driver 140. Ripple eliminator 150 is implemented in the illustrated example by a plurality of capacitors C1 and C2 connected in parallel between the drain terminal and the gate terminal of the second drive transistor. Ripple eliminator 150 prevents the ingress of noise signals into a voltage provided to voltage divider 160. This prevents generation of a ripple (a high frequency noise component) on the output voltage Vout of voltage regulator 100. It is therefore possible to obtain a more stable voltage output (Vout).

According to the voltage regulator operation of voltage regulator 100, the control voltage signal (Vcon) controlling operation of the high voltage transistor forming level down shifter 110 may be generated without providing an additional control circuit. Also, a stable, well-regulated voltage may be obtained. It should be understood, however, that the disclosed embodiment is merely one example of the present invention. For example, the present invention may be applied to the design and implementation of multi level voltage regulator circuits generating a plurality of constant voltages as well as the single constant voltage.

According to the foregoing embodiment of the present invention, it is possible to stably generate a constant voltage output without negatively influencing efforts to reduce overall memory device size.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A voltage regulator, comprising:
a level down shifter reducing a high voltage;
a voltage divider dividing the reduced high voltage to generate a first division result;
a comparator comparing a reference voltage to the first division result to generate a comparison result; and
a driver generating an output voltage based on the comparison result and providing the output voltage to the voltage divider,
wherein the voltage divider divides the output voltage to generate a second division result, the second division result being fed back as a control voltage signal to the level down shifter.

2. The voltage regulator of claim 1, wherein the level down shifter comprises a high voltage, depletion type transistor.

3. The voltage regulator of claim 2, wherein the high voltage depletion type transistor reduces the high voltage using an internal channel formed during inactive periods of the voltage regulator.

4. The voltage regulator of claim 3, wherein the reduced high voltage generated during inactive periods of the voltage regulator corresponds to the high voltage minus a threshold voltage for the high voltage depletion type transistor.

5. The voltage regulator of claim 2, wherein the high voltage depletion type transistor reduces the high voltage in response to the control voltage signal during active periods of the voltage regulator.

6. The voltage regulator of claim 5, wherein the control voltage signal adjusts a width of a channel formed in the high voltage depletion type transistor during active periods of the voltage regulator.

7. The voltage regulator of claim 1, wherein the control voltage signal has a predetermined level lower than the level of the output voltage.

8. The voltage regulator of claim 7, wherein the output voltage and the control voltage signal respectively converge to a predetermined level during active periods of the voltage regulator.

9. The voltage regulator of claim 1, wherein the reduced high voltage is lower than a lowest breakdown voltage for transistors forming the voltage divider, comparator, and driver.

10. The voltage regulator of claim 2, wherein the reduced high voltage is a higher than or equal to a sum of a threshold voltage of the high voltage depletion type transistor and the control voltage signal.

11. A voltage regulator generating an output voltage at an output terminal, comprising:
a level down shifter reducing a high voltage;
a switch receiving the reduced high voltage and an enable signal;
a first driver gated by an output of the switch to output the reduced high voltage;
a second driver gated by the output of the first driver to output the reduced high voltage as the output voltage at the output terminal;
a ripple eliminator connected between the output of the first driver and the output terminal;
a voltage divider dividing the output voltage provided by the second driver to generate a first division result and a second division result; and
a comparator comparing a reference voltage to the first division result to generate a comparison result, wherein the second driver generates the output voltage in relation to the comparison result voltage divider, and
wherein the second division result is fed back as a control voltage signal to the level down shifter.

12. The voltage regulator of claim 11, wherein the level down shifter comprises a high voltage, depletion type transistor.

13. The voltage regulator of claim 12, wherein the high voltage depletion type transistor reduces the high voltage using an internal channel formed during inactive periods of the voltage regulator defined by the enable signal.

14. The voltage regulator of claim 13, wherein the reduced high voltage generated during inactive periods of the voltage regulator corresponds to the high voltage minus a threshold voltage for the high voltage depletion type transistor.

15. The voltage regulator of claim 12, wherein the high voltage depletion type transistor reduces the high voltage in response to the control voltage signal during active periods of the voltage regulator defined by the enable signal.

16. The voltage regulator of claim 15, wherein the control voltage signal adjusts a width of a channel formed in the high voltage depletion type transistor during active periods of the voltage regulator defined by the enable signal.

17. The voltage regulator of claim 11, wherein the control voltage signal has a predetermined level lower than the level of the output voltage.

18. The voltage regulator of claim 17, wherein the output voltage and the control voltage signal respectively converge to a predetermined level during active periods of the voltage regulator defined by the enable signal.

19. The voltage regulator of claim 11, wherein the reduced high voltage is lower than a lowest breakdown voltage for transistors forming the voltage divider, comparator, and driver.

20. The voltage regulator of claim 12, wherein the reduced high voltage is a higher than or equal to a sum of a threshold voltage of the high voltage depletion type transistor and the control voltage signal.
